(19) United States
(12) Patent Application Publication
(10) Pub. No.: US 2024/0125958 A1
(43) Pub. Date: Apr. 18, 2024

(54) Robust Stochastic Seismic Inversion with New Error Term Specification

(71) Applicant: BP Corporation North America Inc., Houston, TX (US)

(72) Inventor: Jingfeng ZHANG, Katy, TX (US)

(73) Assignee: BP Corporation North America Inc., Houston, TX (US)

(21) Appl. No.: 18/476,017

(22) Filed: Sep. 27, 2023

Related U.S. Application Data
(60) Provisional application No. 63/378,963, filed on Oct. 10, 2022.

(51) Int. Cl. G01V 1/30

(52) U.S. Cl. CPC G01V 1/30; G01V 2210/30

(57) ABSTRACT

A method includes receiving observed seismic data, determining an envelope or magnitude of the observed seismic data as a first observed value, generating a variable noise term based in part upon the first observed value, and utilizing the variable noise term to determine a likelihood function of a stochastic inversion operation. The method also includes utilizing the likelihood function to generate a posterior probability distribution in conjunction with the stochastic inversion operation and applying the posterior probability distribution to characterize a subsurface region of Earth.

### CROSS-REFERENCE TO RELATED APPLICATIONS

This application claims benefit of U.S. provisional patent application Ser. No. 63/378,963 filed Oct. 10, 2022, and entitled “Robust Stochastic Seismic Inversion with New Error Term Specification,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to analyzing seismic data, and more specifically, to utilizing improved stochastic seismic inversion techniques in prediction of reservoir properties.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

In conjunction with the creation of an image or profile of a subsurface region, integration of petrophysical data (e.g., physical and/or chemical rock properties, including their interactions with fluids), seismic data, and/or geological information is used in generation of estimates of reservoir properties or reservoir characterization. These estimates and reservoir characterizations are useful in seismic analysis and interpretation of a formation. Stochastic inversion provides one technique for the prediction of reservoir properties or reservoir characterization and improvements to existing stochastic inversion techniques may be desirable.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Reservoir and or formation characterization have advantageous uses for well planning, reserve estimation, reservoir model building, such as production history matching and prediction, and the like. One technique for providing an estimate of reservoir properties and associated uncertainties utilizes stochastic inversion and, more particularly, Bayesian stochastic inversion. Bayesian stochastic inversion provides volumes of reservoir properties and their associated uncertainties (e.g., uncertainty volumes). However, when utilizing a Bayesian stochastic inversion algorithm, the choice of “noise/error” term has significant impact on the final results, since the noise/error term directly affects the shape and/or spread of the likelihood and posterior distribution.

One technique for the selection of the noise/error term of the Bayesian stochastic inversion algorithm either treats the noise/error term as part of uncertainty inversion result, and/or utilize specification to describe coherent noise in the inversion algorithm. However, this technique has potential issues in that it is complex and requires additional processing and/or introduces additional complexity into the Bayesian stochastic inversion algorithm which, accordingly, can reduce the usefulness of any product utilizing this technique. Another technique for the selection of the noise/error term of the Bayesian stochastic inversion algorithm includes setting the noise/error term as constant (i.e., a predetermined value that may be selected, for example, by a user). The constant noise/error term has advantages in its simplicity; however, when implemented, there exists a potential for causing significant bias in the inversion result by focusing on too much attention on the stronger events that occur. Furthermore, when utilizing the constant noise/error term for the Bayesian stochastic inversion algorithm, differences in results may occur whenever the wavelet has changed.

Thus, an additional technique for the selection of the noise/error term of the Bayesian stochastic inversion algorithm may be undertaken in place of either of the aforementioned techniques. For example, the technique can include specifying the noise/error term in the likelihood function as having a balanced focus on the strong and weak events, for example, in the seismic gathers at one common depth point (CDP) or gathers at different CDPs. Additionally, the technique for setting the noise/error term is less affected by the wavelet scalar changes relative to, for example, a selected constant noise/error term.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system;

FIG. 2 illustrates a marine survey system in a marine environment;

FIG. 3 illustrates a land survey system in a land environment;

FIG. 4 illustrates a computing system that may perform operations described herein based on data acquired via the marine survey system of FIG. 2 and/or the land survey system of FIG. 3;

FIG. 5 illustrates a graph of a first example of a posterior probability distribution generated using a first selected constant value as an error term;

FIG. 6 illustrates a graph of a second example of a posterior probability distribution generated using a second selected constant value as an error term;

FIG. 7 illustrates a graph of a seismic gather having various angles that is generated utilizing a selected constant value for a likelihood function stochastic inversion algorithm;

FIG. 8 illustrates a flow chart of a method for the generation of variable values for use in a likelihood function of a stochastic inversion algorithm; and

FIG. 9 illustrates a graph illustrating the variable values used in the likelihood function described in conjunction with FIG. 8.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. As used herein, the terms “approximately,” “about,” “substantially,” and the like mean within 10% (i.e., plus or minus 10%) of the recited value.

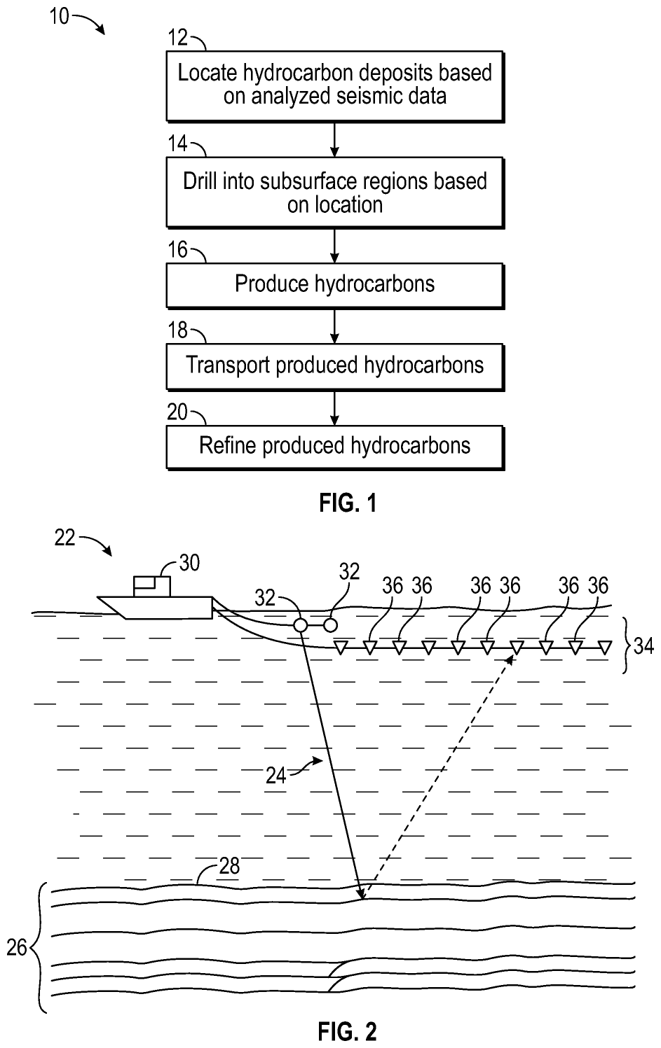

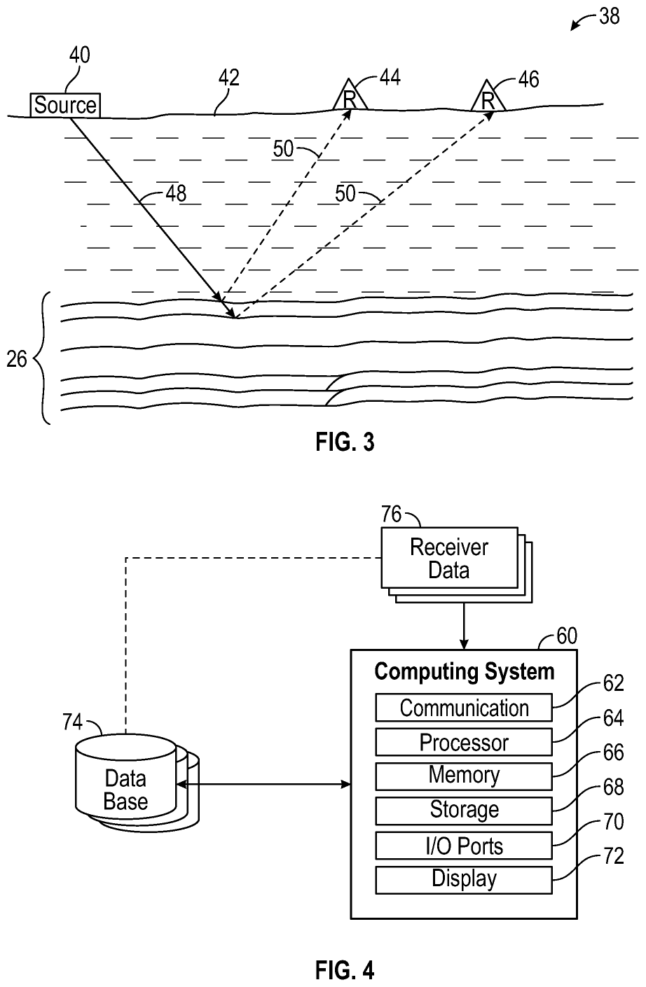

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. Furthermore, vessel 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data. More generally, the acquired seismic data can be applied to characterize a subsurface region 26 of the Earth. In this manner, it can be applied in a number of geological systems, including geothermal, wind pylon siting, other elements of the hydrocarbon systems such as seals, source rocks, etc. and in, for example, reservoir characterization.

In some embodiments, the results of the seismic data analysis may be generated in conjunction with a seismic processing scheme that includes seismic data collection, editing of the seismic data, initial processing of the seismic data, signal processing, conditioning, and imaging (which may, for example, include production of imaged sections or volumes (which may, for example, include production of imaged sections or volumes) in prior to any interpretation of the seismic data, any further image enhancement consistent with the exploration objectives desired, generation of attributes from the processed seismic data, reinterpretation of the seismic data as needed, and determination and/or generation of a drilling prospect or other seismic survey applications. As a result, location of hydrocarbons within a subsurface region 26 may be identified. Additionally, it may be desirable to estimate reservoir or formation properties of a subsurface region 26. Techniques for reservoir characterization may utilize stochastic inversion, which will be described in greater detail below (although it should be noted that these techniques may additionally and/or alternatively applied to a number of geological systems, including geothermal, wind pylon siting, other elements of the hydrocarbon systems such as seals, source rocks, etc. and, more generally applied in characterizing a subsurface region 26 of Earth).

The identification of the lithology (i.e., facies, which may be bodies or layers of substances or rock formations with specified characteristics) of a subsurface region 26 of the Earth is useful in reservoir characterization (or in other characterization of a subsurface region 26 of the Earth in conjunction with other geological systems) because physical and chemical properties of the subsurface region 26 that holds hydrocarbons and/or water affect responses of tools utilized to determine reservoir properties. For example, calculations of porosity, water saturation (S w), and permeability rely on the lithology of the reservoir. One technique for providing an estimate of reservoir properties and associated uncertainties utilizes stochastic inversion, for example, Bayesian stochastic inversion. As an initial matter, Bayes rule can be expressed as:

$$p ( x \vert {D}_{obs} ) = \frac{p ( {D}_{obs} \vert x ) p ( x )}{p ( {D}_{obs} )} ∝ p ( {D}_{obs} \vert x ) p ( x ) \qquad ( Equation 1 )$$

In conjunction with Equation 1, p(x|D_{obs}) is the posterior probability distribution (probability) of an unknown x, e.g., which can be pressure wave velocities or densities for a given set of observed data (D_{obs}), whereby the samples from the distribution can be provided as solutions to the inverse problem. Additionally, p(D_{obs}|x) is the likelihood function and p(x) represents the prior distribution (e.g., a multivariate Gaussian distribution) while p(D_{obs}) represents the probability of the observed data (e.g., evidence). Furthermore, as noted in Equation 1, the posterior probability distribution (i.e., p(x|D_{obs})) is proportional to p(D_{obs}|x) p(x). This can be further represented below:

$$p ( {D}_{obs} \vert x ) p ( x ) ∝ {e}^{- \frac{1}{2} {( {D}_{obs} - D ( x ) )}^{T} {Σ}_{e}^{- 1} ( {D}_{obs} - D ( x ) )} {e}^{- \frac{1}{2} {( x - {x}_{m} )}^{T} {{Σ}_{p}^{- 1} ( x - {x}_{m} )}^{T}} \qquad ( Equation 2 )$$

In conjunction with Equation 2,

$${e}^{- \frac{1}{2} {( x - {x}_{m} )}^{T} {{Σ}_{p}^{- 1} ( x - {x}_{m} )}^{T}}$$

represents the prior distribution, while “Σₑ” therein represents the noise/error term of the Bayesian stochastic inversion algorithm. When utilizing a Bayesian stochastic inversion algorithm, the choice of a noise/error term has significant impact on the final results, since the noise/error term directly affects the shape and/or spread of the likelihood and posterior distribution.

One technique for the selection of the noise/error term of the Bayesian stochastic inversion algorithm either treats the noise/error term as part of uncertainty inversion result, and/or utilize specification to describe coherent noise in the inversion algorithm. For example, one technique may include inverting for combined uncertainty of wavelet, noise, and the subsurface region 26. Another technique for the selection of the noise/error term may include the use of colored noise and white noise in conjunction for use in simulating coherent noise in gathers. However, these techniques have been found to introduce complexity and requirements of additional processing into the Bayesian stochastic inversion algorithm. This can reduce the usefulness of the algorithm as it increases in complexity.

Another technique for the selection of the noise/error term of the Bayesian stochastic inversion algorithm includes setting the noise/error term as an identity matrix scaled by a constant (i.e., a predetermined value that may be selected, for example, by a user). One example of a constant noise/error term is illustrated below:

Σₑ=σ²I (Equation 3)

In conjunction with Equation 3, Σₑ represents the noise/error term, σ is selected as a constant (e.g., a predetermined constant value or a user selected constant value), and I represents an identity matrix. In this manner, Equation 3 represents the noise/error term as a constant scaled identity matrix (i.e., zeros at all locations except for the values on the diagonal of the matrix, which has the constant at its respective locations). For

$$[ \begin{matrix}{σ}_{1}^{2} & ⋯ & 0 \\ ⋮ & ⋱ & ⋮ \\ 0 & ⋯ & {σ}_{1}^{2}\end{matrix} ]$$

example, represents the constant scaled identity matrix for a specified constant. Use of setting the noise/error term as constant does have advantages over the previously discussed technique for selection of the noise/error term, specifically ease of computation. However, there can exist issues in utilizing this constant scaled identity matrix set forth in Equation 3.

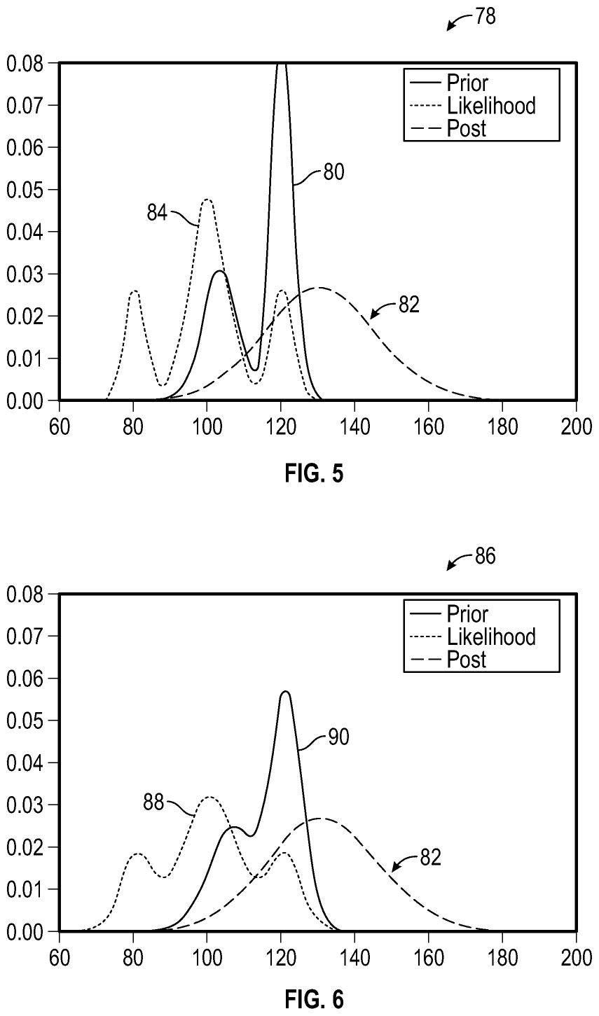

For example, FIG. 5 illustrates a graph 78 of a generated posterior probability distribution 80 that is generated based on a prior distribution 82 and a likelihood distribution 84 generated using a first selected constant value for σ. The prior distribution 82, as illustrated, is a single variable Gaussian distribution. Additionally, the likelihood distribution 84 is generated, as noted above, with selection of a first constant value as utilized, for example, in conjunction with Equation 3. The prior distribution 82 and the likelihood distribution 84 are combined (e.g., multiplied) to generate the posterior probability distribution 80.

However, the posterior probability distribution 80 that is generated will vary greatly when different values for σ are selected. For example, FIG. 6, illustrates a graph 86 that includes the same prior distribution 82 as used in FIG. 5. However, a second selected constant value for σ is chosen that differs from the first selected constant value for σ utilized in conjunction with FIG. 6. This results in a likelihood distribution 88 that is generated in conjunction with Equation 3. As can be seen, the likelihood distribution 88 of FIG. 6 differs from the likelihood distribution 84 of FIG. 5 based upon the selection of a different value for σ. Furthermore, as illustrated in FIG. 6, a posterior probability distribution 90 is generated based upon the prior distribution 82 and the likelihood distribution 88 being combined (e.g., multiplied). Review of FIG. 5 and FIG. 6 illustrate the large differences in the result generated (i.e., differences in posterior probability distribution 80 and posterior probability distribution 90) based upon differences in selection of the constant for σ. Thus, utilizing the constant scaled identity matrix set forth in Equation 3 does reduce complexity; however, the results generated for the posterior probability distribution are dependent upon selection of a correct constant, which may not always be easily identifiable.

Indeed, as illustrated in FIGS. 5 and 6, Σₑ (representing the noise/error term) is an important variable in generating the likelihood distribution. Furthermore, when utilizing a selected constant value for a, additional issues may arise, for example, an increased susceptibility to wavelet changes. Indeed, results generated utilizing a first wavelet and results generated using a second wavelet that is reduced relative to the first wavelet (i.e., consistent with the first wavelet but smaller in value) will yield drastically different results for the generated posterior probability distribution. An additional issue that may arise when selecting a constant value for σ is that there is a lowered requirement of matching weaker seismic angles/events/areas.

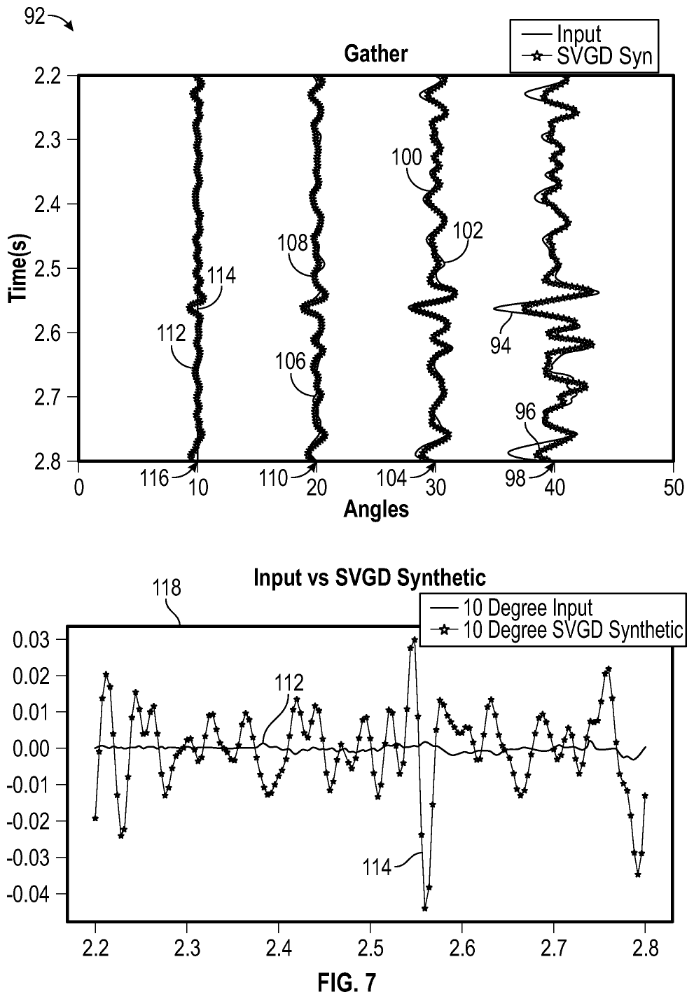

For example, FIG. 7 illustrates a graph 92 illustrating a seismic gather having various angles. As illustrated, the input data 94 is matched well percentage-wise with the modeled synthetic data 96 at a first angle 98 (e.g., the farthest angle and the right most trace). As illustrated, the input data 100 is also matched well percentage-wise with the modeled synthetic data 102 at a second angle 104 (e.g., the second farthest angle). The input data 106 is matched reasonably well percentage-wise with the modeled synthetic data 108 at a third angle 110 (e.g., the third farthest angle) and the input data 112 is matched least well percentage-wise with the synthetic data 114 at a fourth angle 116 (e.g., the left most trace, or the smallest angle). Indeed, graph 118 better illustrates the differences between the input data 112 and the synthetic data 114 at the fourth angle 116.

Thus, FIG. 7 graphically illustrates that when using a constant value for a, the larger events are prioritized such that their matching with the input data is better percentage-wise compared to the weaker events; i.e., there is a lowered requirement of matching weaker seismic events. This is true for angles/areas with weaker seismic events and this results in less reliable posterior probability distribution.

A physical meaning of the noise/error term (e.g., Σₑ) is a measurement of how severe a mismatch is between input data (e.g., observed data) and modeled synthetic data. That is, the noise/error term, utilizing a constant value for a, represents, for example, a distance from a center of a distribution, not as the noise/error itself but as a metric to represent the severity of the mismatches. Setting a as constant has the result that any fixed value of mismatches in data will be considered equally serious, regardless of how strong the seismic event is. Thus, for small events, the use of a constant value for a represents greater tolerance for mismatches between synthetic data and input data (graph 118) relative to large events (e.g., at angle 98).

Thus, an additional technique for the selection of the noise/error term of the Bayesian stochastic inversion algorithm may be undertaken in place of the previously described techniques. This technique for the selection of the noise/error term of the Bayesian stochastic inversion algorithm includes setting the noise/error term as variable value. In discussion of utilization of the variable noise/error term, we can again refer to Equation 3:

$${Σ}_{e} = [ \begin{matrix}{σ}_{1}^{2} & ⋯ & 0 \\ ⋮ & ⋱ & ⋮ \\ 0 & ⋯ & {σ}_{n}^{2}\end{matrix} ] \qquad ( Equation 4 )$$

As discussed above, Σₑ represents the noise/error term and are various values that need to be calculated.

In some embodiments, σ can be generated as follows:

$$σ = \frac{Env ( {D}_{obs} )}{\sqrt{SNR}} \qquad ( Equation 5 )$$

In conjunction with Equation 5, Env(D_{obs}) is the envelope (e.g., a representation of phase-independent amplitude) of the observed data, or some smoothed magnitude of the input seismic, and the signal-to-noise ratio (SNR) is the measured or determined seismic signal to noise ratio. It should be noted that the SNR may be angle-dependent. Because of the value of σ generated in conjunction with Equation 5 varies with the observed data (and, for example, with the SNR of that observed data), when σ is calculated and applied in Equation 4, it results in a diagonal matrix with variable diagonal components.

Using the technique described above, applying Equation 5 to calculate a variable value for σ then applying the respective values calculated with respect to Equation 4 generates results that have greater immunity to wavelet scaling and changes of signal strength. In this manner, the above described technique alleviates many of the issues raised above with respect to utilizing a selected constant value for σ. Moreover, the complexity added relative to the selected constant value for σ is minimal relative to more complex techniques, such as selection of the noise/error term of the Bayesian stochastic inversion algorithm by treating the noise/error term as part of uncertainty inversion result, and/or by describing coherent noise in the inversion algorithm.

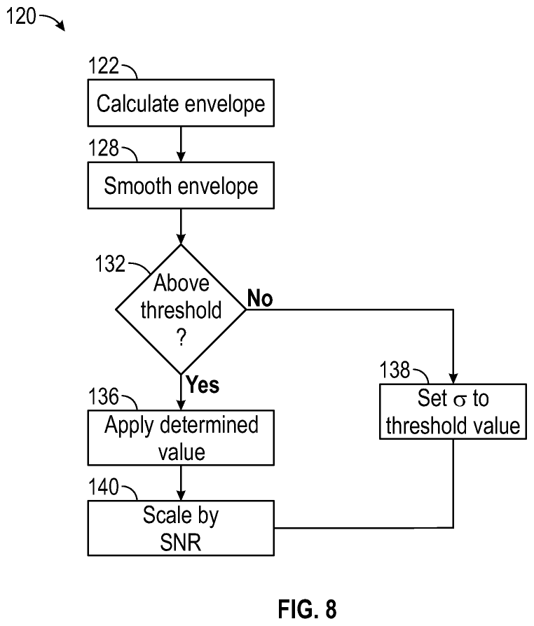

In other embodiments, the technique described above may be modified. For example, FIG. 8 illustrates flow chart of a method 120 as a technique for the generation of variable values for σ for application to Equation 4. The method of 120, as well as the techniques previously described, can be implemented and/or performed by the computing system 60, although it should be understood that the method 120 (as well as the techniques previously discussed) may be performed by any suitable computing system, computing device, and/or controller. In this way, it should also be understood that some or all of the below described processing operations may be performed by one or more components of the computing system 60, including the processor 64, the memory 66, or the like, and may be executed by the processor 64, for example, executing code, instructions, commands, or the like stored in the memory 66 (e.g., a tangible, non-transitory, computer-readable medium).

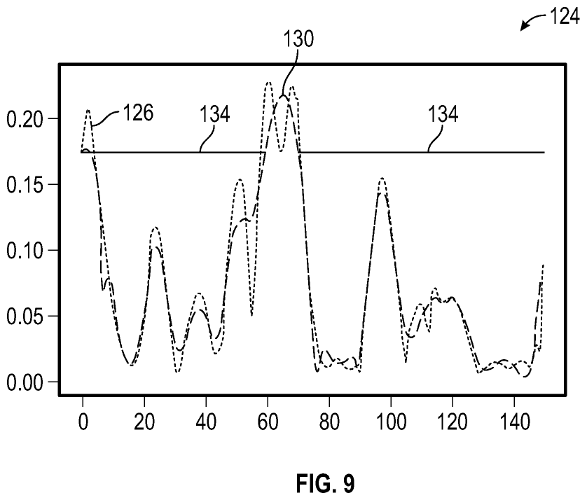

In step 122 an envelope of the observed data is calculated (or some smoothed version of the magnitude of the seismic data). This may be done for every data point in the observed data and, for example, may be part of a seismic gather. The graph 124 in FIG. 9 illustrates the results of step 122 in which the envelope 126 is generated. Returning to FIG. 8, in step 128, the calculated envelope may be smoothed (i.e., filtered) to remove and/or reduce high frequency elements of the calculated envelope. FIG. 9 illustrates the smoothed envelope 130 that is generated as a result of step 128. Step 128 may be skipped by user. That is, in some embodiments, step 128 is optionally performed. However, in other embodiments, step 128 can be omitted and method 120 may instead proceed from step 122 to step 132.

Returning to FIG. 8, in step 132 a determination is made for each data point of the envelope of whether its value exceeds a threshold value. This threshold value can be set as the value that separates strongest 20% of 130 from the bottom 80% for each angle, or for all angles. FIG. 9 illustrates an example of the threshold value 134. The threshold value 134 may be a set value applied as σ if the value of the envelope at a given data point is below the threshold value 134 (or, for example, is equal to or below the threshold value 134), as illustrated in step 138 of method 120 of FIG. 8. Alternatively, in conjunction with step 138, the actual value of the envelope for a given data point is applied as σ if the value of the envelope at the given data point exceeds the threshold value 134 (or, for example, is equal to or above the threshold value 134). It should be noted that when the value of the envelope at the given data point is the same as the threshold value 134, the value set as σ is the threshold value as well as the envelope value and this process can be made in conjunction with either step 136 or step 138.

In step 140, the value selected for σ is scaled by the seismic SNR value associated with the data point. Moreover, as noted above, the process described in conjunction with method 120 is performed for each diagonal component in Equation 4. Use of method 120 may result in greater stability in the posterior probability distribution.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving observed seismic data;
determining an envelope or magnitude of the observed seismic data as a first observed value;
generating a variable noise term based in part upon the first observed value;
utilizing the variable noise term to determine a likelihood function of a stochastic inversion operation;
utilizing the likelihood function to generate a posterior probability distribution in conjunction with the stochastic inversion operation; and
applying the posterior probability distribution to characterize a subsurface region of Earth.

2. The method of claim 1, comprising generating the variable noise term based at least in part upon a signal to noise ratio of the observed seismic data.

3. The method of claim 2, comprising generating the variable noise term by dividing a smoothed envelope or magnitude of the observed seismic data as the first observed value by a square root of the signal to noise ratio of the observed seismic data.

4. The method of claim 1, comprising determining whether a first data point of the first observed value exceeds a threshold value.

5. The method of claim 4, comprising setting the threshold value based upon the observed seismic data.

6. The method of claim 4, comprising utilizing the variable noise term to determine the likelihood function when the first data point exceeds the threshold value.

7. The method of claim 4, utilizing the threshold value as the variable noise term to determine the likelihood function when the first data point is below the threshold value.

8. A tangible, non-transitory, machine-readable media, comprising instructions configured to cause a processor to:
receive observed seismic data;
determine an envelope or magnitude of the observed seismic data as a first observed value;
generate a variable noise term based in part upon the first observed value;
utilize the variable noise term to determine a likelihood function of a stochastic inversion operation;
utilize the likelihood function to generate a posterior probability distribution in conjunction with the stochastic inversion operation; and
apply the posterior probability distribution to characterize a subsurface region of Earth.

9. The tangible, non-transitory, machine-readable media of claim 8, comprising instructions configured to cause the processor to generate the variable noise term based at least in part upon a signal to noise ratio of the observed seismic data.

10. The tangible, non-transitory, machine-readable media of claim 9, comprising instructions configured to cause the processor to generate the variable noise term by dividing a smoothed envelope or magnitude of the observed seismic data as the first observed data by a square root of the signal to noise ratio of the observed seismic data.

11. The tangible, non-transitory, machine-readable media of claim 10, comprising instructions configured to cause the processor to determining whether a first data point of the first observed value exceeds a threshold value.

12. The tangible, non-transitory, machine-readable media of claim 11, comprising instructions configured to cause the processor to set the threshold value based upon the observed seismic data.

13. The tangible, non-transitory, machine-readable media of claim 12, comprising instructions configured to cause the processor to utilize the variable noise term to determine the likelihood function when the first data point exceeds the threshold value.

14. The tangible, non-transitory, machine-readable media of claim 13, comprising instructions configured to cause the processor to utilize the threshold value as the variable noise term to determine the likelihood function when the first data point is below the threshold value.

15. A method, comprising:
receiving observed seismic data;
determining an envelope of the observed seismic data;
generating a variable noise term based in part upon the envelope of the observed seismic data;
determining whether a value of the variable noise term is above a threshold value;
utilizing the variable noise term to determine a likelihood function of a stochastic inversion operation when the value of the variable noise term is determined to be above the threshold value;
utilizing the likelihood function to generate a posterior probability distribution in conjunction with the stochastic inversion operation; and
applying the posterior probability distribution to characterize a subsurface region of Earth.

16. The method of claim 15, comprising utilizing the threshold value to determine the likelihood function of the stochastic inversion operation when the value of the variable noise term is determined to be at or below the threshold value.

17. The method of claim 16, comprising generating the variable noise term based at least in part upon a signal to noise ratio of the observed seismic data.

18. The method of claim 17, comprising generating the variable noise term by dividing the envelope of the observed seismic data by a square root of the signal to noise ratio of the observed seismic data.

19. The method of claim 15, wherein determining an envelope of the observed seismic data comprises filtering the envelope of the observed seismic data to generate a smoothed envelope as envelope of the observed seismic data.

20. The method of claim 19, comprising setting the threshold value to be greater than a fixed percentage of the smoothed envelope.
